(19) United States
(12) Patent Application Publication
(10) Pub. No.: US 2026/0125120 A1
(43) Pub. Date: May 7, 2026

(54) KINGPIN DEVICE WITH LIMIT SENSORS FOR CONTROLLING ELECTRIC AXLE DRIVE ON SEMI-TRAILERS

(71) Applicant: FACCHINI S.A., São José do Rio Preto (BR)

(72) Inventor: Rubens Facchini, São José do Rio Preto (BR)

(21) Appl. No.: 19/383,575

(22) Filed: Nov. 7, 2025

(30) Foreign Application Priority Data
Nov. 7, 2024 (BR) 102024023271 2

(51) Int. Cl. B62D 53/08; B62D 65/00

(52) U.S. Cl. CPC B62D 53/0842; B62D 65/005

(57) ABSTRACT

The device (2) uses the kingpin (6) of semi-trailers (1) to increase power efficiency and safety by detecting longitudinal forces to control acceleration, braking, and power regeneration with the help of load cells (7) or a hydraulic cylinder (19) with load transducer sensors (20), activating the electric motor during acceleration (A) and regenerative braking during deceleration (D). It can be integrated with systems such as EBS, TCS, and ESC. The device (2) is mounted on the semi-trailer friction plate (1) and sends information to the acceleration/regeneration controls. The device (2) contributes to optimizing vehicle performance, focusing on power savings and safety in transport operations.

### INTRODUCTION

This patent application refers to an unpublished “KINGPIN DEVICE WITH LIMIT SENSORS FOR CONTROLLING ELECTRIC AXLE DRIVE ON SEMI-TRAILERS”, which relates to the use of a kingpin with longitudinal limit load sensors on its axle or pistons to control at least one auxiliary drive axle with an electric motor to help in recovering the power generated during braking and deceleration of semi-trailers, as well as helping the truck to overcome slopes more efficiently.

### FIELD OF APPLICATION

This patent application applies to the road segment, more specifically to semi-trailers with one or more axles equipped with electric motors.

### REASONING

It will be appreciated by a person skilled in the art that the means for controlling electric axles in semi-trailers are complex and multifaceted, often involving advanced technology. Controlling such axles is crucial to ensuring safety, power efficiency, and vehicle performance. Listed below are some of the main control systems currently used.

Electronic Control Systems: Electronic Control Units (ECU): responsible for monitoring and managing electric axle performance by adjusting power and speed as needed. Sensors: used to collect real-time data on speed, torque, and temperature, allowing for dynamic adjustments.

Traction Control Systems (TCS): prevent wheel slip by adjusting the power sent to the axles. Electronic Stability Control (ESC): helps maintain vehicle stability on curves and in adverse conditions.

Torque Control: directly controls engine torque output, ensuring that semi-trailer wheels receive the desired amount of power. Torque control is useful for applications that require accurate control, such as heavy transport or steep slopes.

Field-Oriented Control (FOC): this is a type of vector control that uses engine flux and torque to regulate its performance. It provides high precision and responsiveness, making it suitable for demanding applications.

Regenerative Braking: allows the power generated during braking to be converted into electricity and stored, thus increasing power efficiency.

Electric axles for semi-trailers are an innovative technology that promises to revolutionize cargo transportation with a series of advantages over traditional axles. Electric axles on semi-trailers can recover power while driving downhill or braking, thus reducing fuel consumption and CO₂ emissions. Another prominent factor is that electric axle assistance reduces the strain on truck's engine, especially on slopes, thus increasing system efficiency. Finally, the reduced reliance on the combustion engine contributes to reducing pollutant gas emissions.

Basically, an electric axle for a semi-trailer typically includes an electric motor, an inverter, batteries, and a control system. The electric motor provides additional torque to the wheels, supporting truck traction. While driving downhill or braking, the motor acts as a generator, converting kinetic power into electrical power that is stored in the batteries. This power can then be used to assist the truck when going up or accelerating.

The kingpin is an essential component in the semi-trailer coupling system. It is responsible for connecting the semi-trailer to the tractor unit, ensuring stability and safety during transport, which is essential for articulation and weight distribution.

Within this context, new technologies that enable integration of the kingpin and electric axle systems without causing premature wear on the load cells are welcome in this segment.

### STATE OF THE ART

The current state of the art anticipates some patent documents that refer to kingpins and means for controlling the electric axle on semi-trailers, such as document US20100025131A1, entitled “ELECTRIC PROPULSION SYSTEM”, which describes an electric propulsion system applied to vehicles, comprising a chassis that supports at least one electric motor attached to its suspension. Said document reveals the use of a controller that controls traction and/or stability.

The system anticipated in the document fully controls the electric motors in the traction and stability of the semi-trailer, which is precarious for the entire system.

Document US20110094807A1, entitled “ELECTRIC DRIVE SYSTEM FOR PASSIVE VEHICLE,” eliminates the differential gearbox by using two electric motors that independently drive each wheel of the semi-trailer passive axle, which eliminates the need for a differential gearbox and reduces the weight, complexity, and cost of the system. The electric motors can function as generators, converting braking power into electrical power, which is stored in batteries within the vehicle itself, thus making the system self-sustaining.

The system anticipated in the document does not foresee any control of the electric motors based on the kingpin and fifth wheel.

Document BR102019025012-7 A2, entitled “SISTEMA DE ACOPLAMENTO INTELIGENTE ENTRE IMPLEMENTO RODOVIÁRIO E VEÍCULO TRATOR, SISTEMA E PROCESSO DE GERENCIAMENTO PARA ATUAçÃO DE TRAçÃO AUXILIAR EM IMPLEMENTOS RODOVIÁRIOS [INTELLIGENT COUPLING SYSTEM BETWEEN ROAD IMPLEMENT AND TRACTOR VEHICLE, MANAGEMENT SYSTEM AND PROCESS FOR AUXILIARY TRACTION OPERATION IN ROAD IMPLEMENTS]”, is characterized by comprising at least one sensing system and a control system that receives signals from the sensing system, wherein the control system selects operating modes from the signals sent by the sensing system, controls the auxiliary traction elements and comprises a fifth wheel and kingpin assembly.

In the system anticipated in the document above, the sensors that are present in the fifth wheel and/or kingpin are selected from the group comprising: load sensors, gauges, position sensors, laser sensors, or other sensors that send signals on the relative position, force, or acceleration between the vectors of the tractor vehicle and the road implement. This type of control is susceptible to variation depending on the mechanical wear of the kingpin and/or fifth wheel. In this model, the kingpin has its structure modified to receive the sensors, making replacement difficult.

Document BR102022013122-8 A2, entitled “MÁQUINA ELÉTRICA DE FLUXO AXIAL E PROCESSO DE FABRICAçÃO DE MÁQUINA ELÉTRICA DE FLUXO AXIAL E [AXIAL FLUX ELECTRIC MACHINE AND PROCESS FOR MANUFACTURING AXIAL FLUX ELECTRIC MACHINE],” is characterized in that it is formed in a single block and has a cooling channel for the circulation of a coolant fluid to reduce the temperature due to the heat dissipated by the power produced in the motor. The stator also has a spoked structure, which houses the segments in the spaces formed by the spokes of the structure. This invention applies to the fields of electric machines and electric mobility, such as electric vehicles.

The machine anticipated in the document above is applied to a road implement, comprising at least one drive axle equipped with at least one electric machine capable of providing traction and generating electrical power from a drive axle operating mode, such that the electric machine is of the axial flux type and has a magnetic profile compatible with a previously known demand for the drive axle operation of the road implement.

### OBJECTIVE OF THE INVENTION

This invention aims to propose a kingpin device with limit sensors for controlling electric axle drive on semi-trailers that promotes greater reliability of the information obtained. It is possible to know precisely when the semi-trailer exerts longitudinal loads on the tractor unit. This way, the acceleration/regeneration controls are executed exactly at the intended time.

This invention aims to propose a kingpin device with limit sensors for controlling electric axle drive on semi-trailers that senses the kingpin without altering its original characteristics, thus generating a more accurate control system.

This invention aims to propose a kingpin device with limit sensors for controlling electric axle drive on semi-trailers with great structural simplicity.

This invention aims to propose a kingpin device with limit sensors for controlling electric axle drive on semi-trailers that is easy to maintain.

This invention aims to propose a kingpin device with limit sensors for controlling electric axle drive on semi-trailers that uses an industry-standard kingpin, without requiring the purchase of a special piece.

This invention aims to propose a kingpin device with limit sensors for controlling electric axle drive on semi-trailers that can be done by a load cell or hydraulic pistons.

This invention aims to propose a kingpin device with limit sensors for controlling electric axle drive on semi-trailers that can be integrated with other control systems required for accelerating, braking, or regenerating electric power (accelerometer; inclinometer; transducer; EBS; TCS; ESC).

This invention aims to propose a kingpin device with limit sensors for controlling electric axle drive on semi-trailers with an optimal cost-benefit ratio.

### SUMMARY OF THE INVENTION

The “KINGPIN DEVICE WITH LIMIT SENSORS FOR CONTROLLING ELECTRIC AXLE DRIVE ON SEMI-TRAILERS” relates to the reading of longitudinal load variations on the kingpin by sensing through limit load cells aligned with the kingpin itself, or by means of a hydraulic piston or pistons that, when sensed, emit electrical signals to processors that control acceleration, regeneration, and regenerative braking.

### DESCRIPTION OF THE DRAWINGS

The figures below are presented to better explain the patent application in an illustrative and non-limiting manner:

FIG. 1: Perspective view of the kingpin device with limit sensors for controlling electric axle drive on semi-trailers with load sensors.

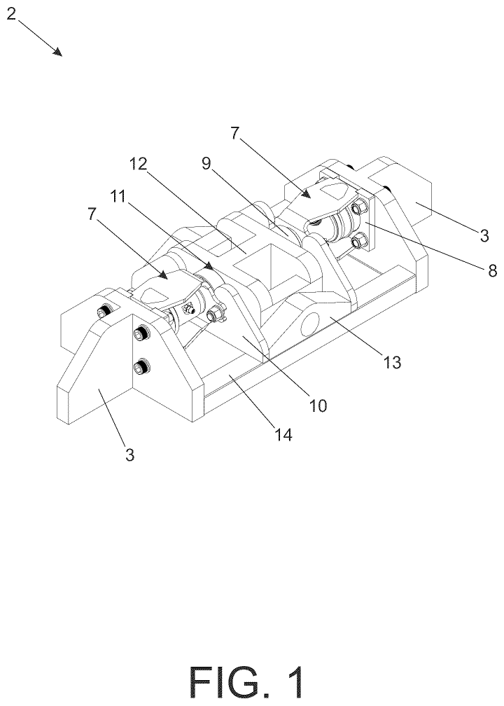

FIG. 2: Inverted perspective view of the kingpin device with limit sensors for controlling electric axle drive on semi-trailers with load sensors.

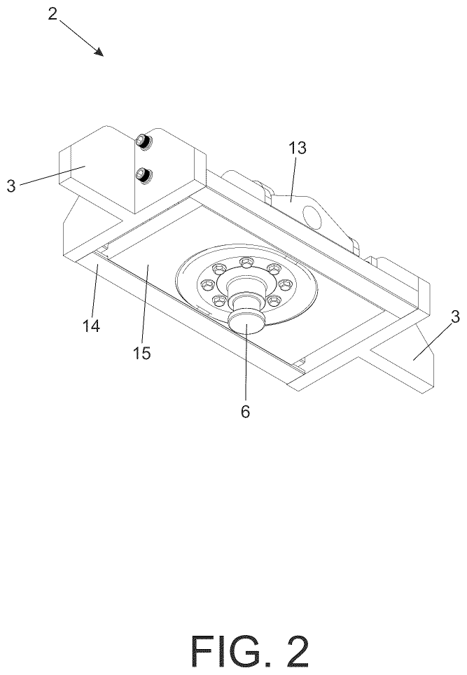

FIG. 3: Exploded perspective view of the kingpin device with limit sensors for controlling electric axle drive on semi-trailers with load sensors.

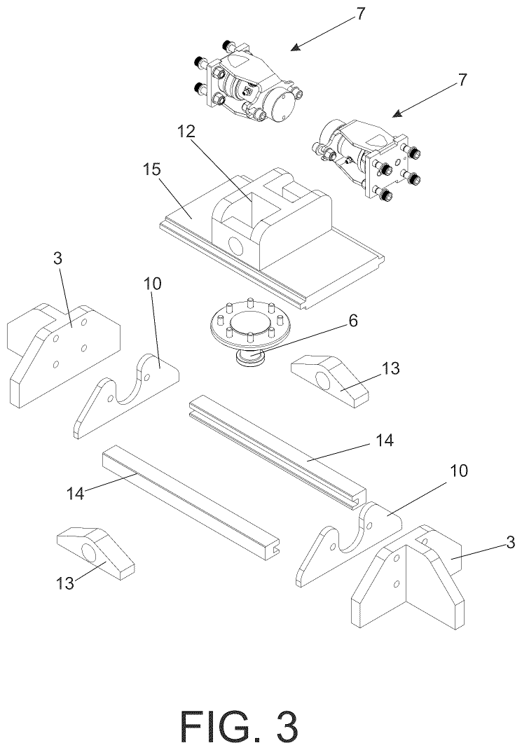

FIG. 4: Inverted exploded perspective view of the kingpin device with limit sensors for controlling electric axle drive on semi-trailers with load sensors.

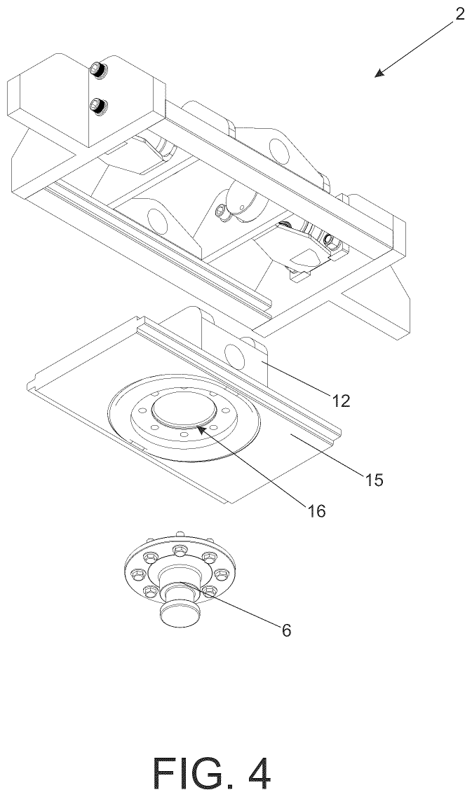

FIG. 5: Side view of the kingpin device with limit sensors for controlling electric axle drive on semi-trailers with load sensors showing stresses.

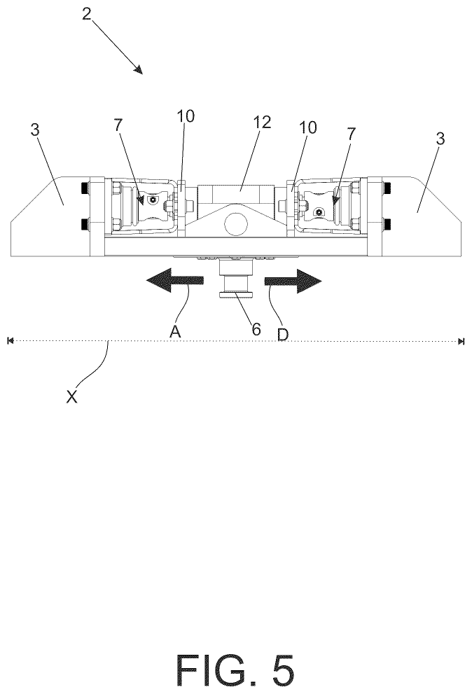

FIG. 6: Perspective view of the kingpin device with limit sensors for controlling electric axle drive on semi-trailers with a cylinder.

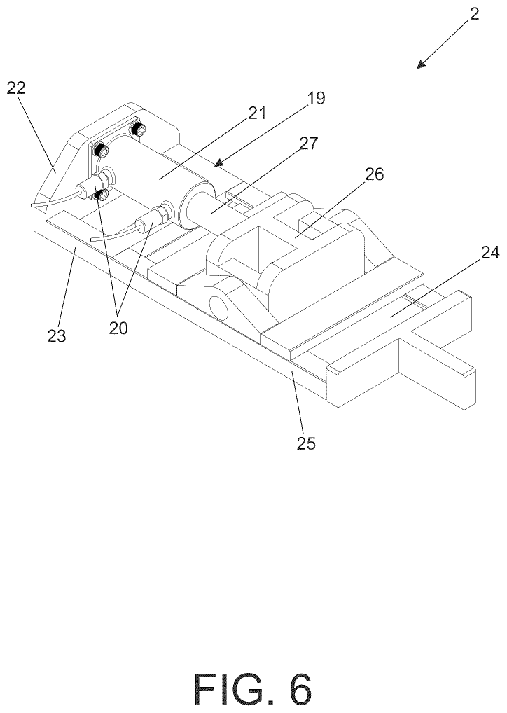

FIG. 7: Inverted perspective view of the kingpin device with limit sensors for controlling electric axle drive on semi-trailers with a cylinder.

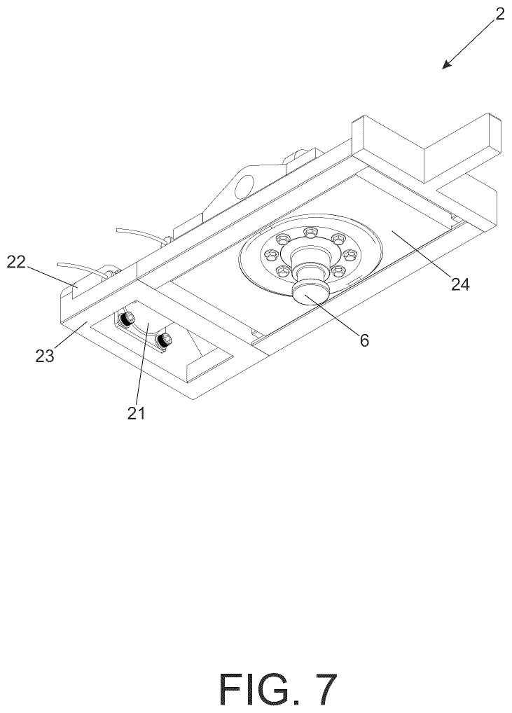

FIG. 8: Exploded perspective view of the kingpin device with limit sensors for controlling electric axle drive on semi-trailers with a cylinder.

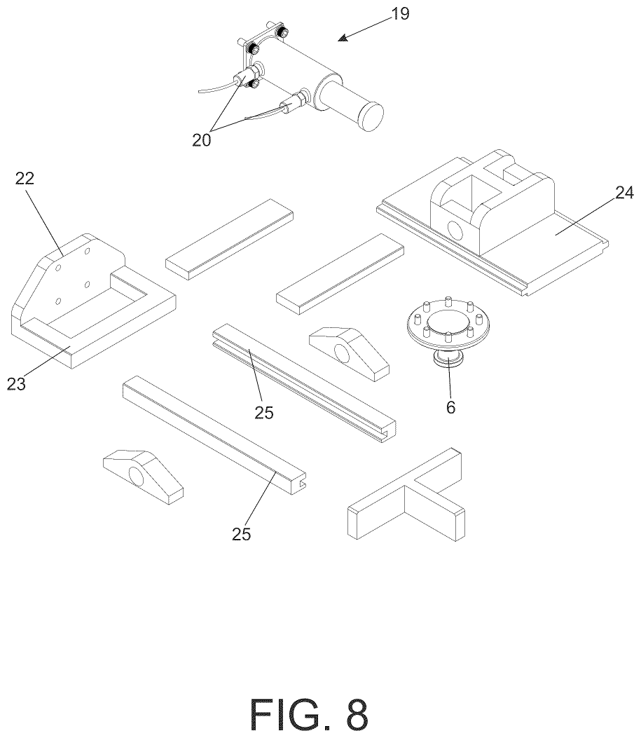

FIG. 9: Perspective view of the kingpin device with limit sensors for controlling electric axle drive on semi-trailers with load sensors showing use thereof.

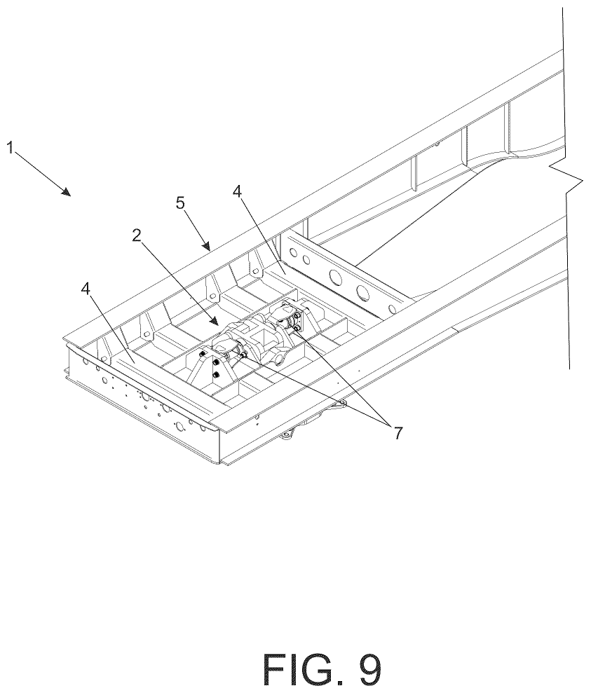

FIG. 10: Inverted perspective view of the kingpin device with limit sensors for controlling electric axle drive on semi-trailers with load sensors showing use thereof.

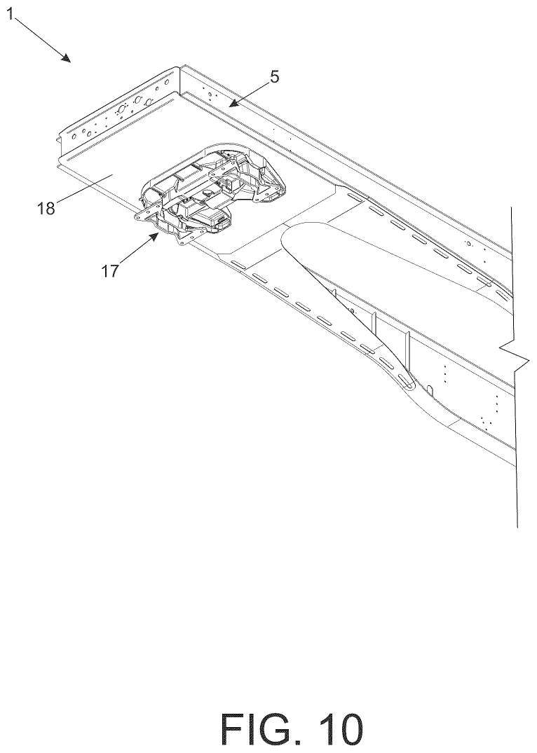

FIG. 11: Perspective view of the kingpin device with limit sensors for controlling electric axle drive on semi-trailers with the cylinder showing use thereof.

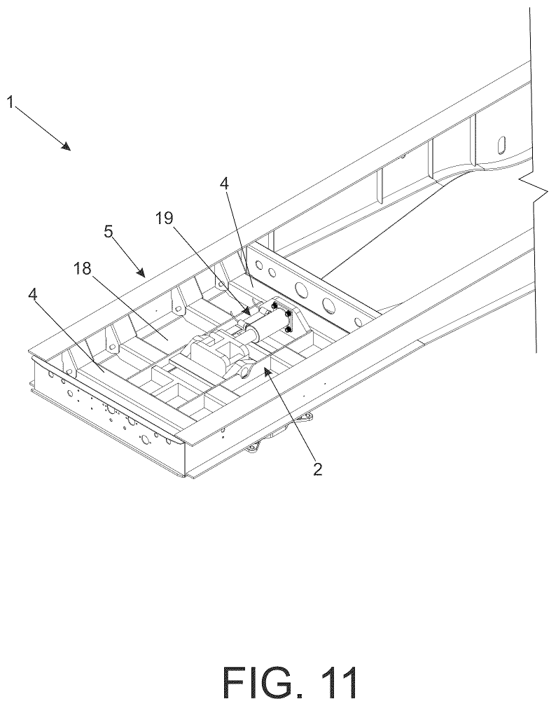

### DETAILED DESCRIPTION OF THE INVENTION

The “KINGPIN DEVICE WITH LIMIT SENSORS FOR CONTROLLING ELECTRIC AXLE DRIVE ON SEMI-TRAILERS”, which is the object of this patent application, uses the kingpin (6) of semi-trailers (1) to increase power efficiency and safety, detecting longitudinal forces to control acceleration, braking, and power regeneration with the help of load cells (7) or a hydraulic cylinder (19) with load transducer sensors (20), activating the electric motor during acceleration (A) and regenerative braking during deceleration (D). It can be integrated with systems such as EBS, TCS, and ESC. The device (2) is mounted on the friction plate of the semi-trailer (1) and sends information to the acceleration/regeneration controls. The device (2) contributes to optimizing vehicle performance, with a focus on power savings and safety in transport operations.

More particularly, the invention claimed herein refers to a “KINGPIN DEVICE WITH LIMIT SENSORS FOR CONTROLLING ELECTRIC AXLE DRIVE ON SEMI-TRAILERS”, in order to obtain greater power efficiency in sets formed by a tractor unit (not demonstrated) and a semi-trailer (1), which has a drive axle with an electric motor, a battery and an electronic control unit. The device (2), which is mounted on these sets, is capable of identifying the best moments to recover and store the power generated and subsequently use it to pull the tractor unit and semi-trailer (1) set on slopes or moments that require greater power from the tractor unit. The device (2) is mounted between two fixed and opposing “T” structures (3) anchored to the most advanced crossbars (4) of the base (5) of the semi-trailer (1), which gives robustness and stability to the kingpin (6) device (2) proposed herein that operates based on load cells (7) neighboring said kingpin (6), which have the front walls (8) fastened to the fixed “T” structures (3) and the rear third (9) supported on a stop (10) having a central recess, so that the distal ends (11) of the load cells (7) have freedom of longitudinal movement (X) towards the central block (12) connected to the side locks (13) overlapping the rails (14) run by the flange (15) with a stop (16) to receive the kingpin (6) that, connected to the fifth wheel (17), copies the acceleration (A) or deceleration (D) movement of the tractor unit and, by electronic means already known, deactivates and activates, respectively, the regeneration that allows small longitudinal displacement in these same directions that send information to the acceleration/regeneration controls exactly at the proposed moment. The device (2) can be integrated with other control systems required to accelerate, brake or regenerate electrical power (accelerometer; inclinometer; transducer; EBS; TCS; ESC). Thus, when the longitudinal force on the kingpin (6) is directed forward, i.e., acceleration (A), the axle(s) with electric motor(s) are activated, providing traction. On the other hand, when the force is directed backward, i.e., deceleration (D), braking or regenerative braking occurs. The kingpin (6) device (1) is mounted on a friction plate assembly (18) on the semi-trailer.

In a constructive option, the device (2) can operate with a hydraulic cylinder (19) with load transducer sensors (20), whose sleeve (21) is fixed to an “L” structure (22) that leads to a fixed platform (23) receiving a flange (24) that slides on rails (25) overlapped by a central block (26) that serves as a stop for the piston (27) of said hydraulic cylinder (19), which flange (24), due to the fact that it supports the kingpin (6), copies the acceleration (A) and deceleration (D) movement of the tractor unit and, by electronic means already known, deactivates and activates, respectively, the regeneration that allows small longitudinal displacement in these same directions that send information to the accelerate/regenerate controls exactly at the proposed moment.

1) “KINGPIN DEVICE WITH LIMIT SENSORS FOR CONTROLLING ELECTRIC AXLE DRIVE ON SEMI-TRAILERS”, capable of identifying the best moments to recover and store the power generated and subsequently use it to pull the tractor unit and semi-trailer (1) set on slopes or moments that require greater power from the tractor unit, wherein it is mounted between two fixed and opposing “T” structures (3) anchored to the most advanced crossbars (4) of the base (5) of the semi-trailer (1). It operates based on load cells (7) neighboring the kingpin (6), whose front walls (8) are fastened to the fixed “T” structures (3) and the rear third (9) is supported by a stop (10) having a central recess; the distal ends (11) of the load cells (7) have freedom of longitudinal movement (X) towards the central block (12) connected to the side locks (13) overlapping the rails (14) run by the flange (15) with a stop (16) to receive the kingpin (6) that, connected to the fifth wheel (17), copies the acceleration (A) or deceleration (D) movement of the tractor unit and, by electronic means already known, deactivates and activates, respectively, the regeneration that allows small longitudinal displacement in these same directions that send information to the accelerate/ regenerate controls exactly at the proposed moment.

2) “KINGPIN DEVICE WITH LIMIT SENSORS FOR CONTROLLING ELECTRIC AXLE DRIVE ON SEMI-TRAILERS”, according to claim 1, wherein the device (2) can be integrated with other control systems required to accelerate, brake, or regenerate electrical power (accelerometer; inclinometer; transducer; EBS; TCS; ESC).

3) “KINGPIN DEVICE WITH LIMIT SENSORS FOR CONTROLLING ELECTRIC AXLE DRIVE ON SEMI-TRAILERS”, according to claim 1, wherein the kingpin (6) device (2) is mounted on a friction plate assembly (18) on the semi-trailer.

4) “KINGPIN DEVICE WITH LIMIT SENSORS FOR CONTROLLING ELECTRIC AXLE DRIVE ON SEMI-TRAILERS”, according to claim 1, wherein the device (2) operates with a hydraulic cylinder (19) with load transducer sensors (20), whose sleeve (21) is fixed to an “L” structure (22) that leads to a fixed platform (23) receiving a flange (24) that slides on rails (25) overlapped by a central block (26) that serves as a stop for the piston (27) of said hydraulic cylinder (19).
